(19) United States
(12) Patent Application Publication
(10) Pub. No.: US 2019/0315571 A1
(43) Pub. Date: Oct. 17, 2019

(54) Method, System and Apparatus for Determining Number of Products

(71) Applicant: Omni Consumer Products, LLC, Addison, TX (US)

(72) Inventors: Stephen Howard, Dallas, TX (US); Larry McNutt, Carrollton, TX (US); Richard Ward Adkisson, Little Elm, TX (US)

(21) Appl. No.: 16/290,463

(22) Filed: Mar. 1, 2019

Related U.S. Application Data
(63) Continuation-in-part of application No. PCT/US2018/045664, filed on Aug. 7, 2018.
Application No. PCT/US2018/045664 is a continuation-in-part of application No. 15/394,799, filed on Dec. 29, 2016.
Application No. 15/394,799 is a continuation-in-part of application No. 15/258,973, filed on Sep. 7, 2016, now abandoned.
(60) Provisional application No. 62/637,381, filed on Mar. 1, 2018.

(51) Int. Cl. B65G 43/08; G06N 20/00

(52) U.S. Cl. CPC B65G 43/08; G06N 20/00

(57) ABSTRACT

A product counting method, apparatus and system. The product counting system includes an intelligent module. The intelligent module has a processor, beam module, an artificial intelligence, and movement module. The movement module determines a movement in product line, where the product line increases or decreases by adding or removing product, and where the distance of the product line from the product counting system is determined by the processor utilizing the beam module. The change in distance from the product line is utilized by the artificial intelligence module to learn at least one of the measurement of the product, the description of the product and the number of product added or removed from the product line.

### CROSS REFERENCE TO RELATED APPLICATIONS

This application is a continuation in part of PCT/US2018/045664 filed on Aug. 7, 2018 and U.S. application Ser. No. 15/394,799 filed on Dec. 29, 2016, which is a continuation-in-part of U.S. application Ser. No. 15/258,973, filed on Sep. 7, 2016. This application also claims benefit and priority from U.S. Provisional Application No. 62/637,381 filed on Mar. 1, 2018. The above identified patent applications are incorporated herein by reference in their entirety to provide continuity of disclosure.

### FIELD OF THE INVENTION

The disclosure relates to systems, apparatus and methods for determining the number of products. More specifically, this disclosure relates to facilitating learning the number of products at a location without the use of sensors and/or without the need to be physically at the location.

### BACKGROUND OF THE INVENTION

Background determining number of products is in a location is a costly and time-consuming activity. When the count is done by personnel, the personnel are required to be at the location and the margin of error is increased. Sensor technology have been introduced to minimize the cost, time and margin or error. However, sensors introduce a technical complexity and challenges. In most cases, sensors require large amount of data to be archived. Also, sensor technology is limited by distance, high precision aim and customization by product.

### SUMMARY OF THE INVENTION

Embodiments described herein relate to a product counting method, apparatus and system. The product counting system includes an intelligent module. The intelligent module has a processor, beam module, an artificial intelligence, and movement module. The movement module determines a movement in product line, where the product line increases or decreases by adding or removing product, and where the distance of the product line from the product counting system is determined by the processor utilizing the beam module. The change in distance from the product line is utilized by the artificial intelligence module to learn at least one of the measurement of the product, the description of the product and the number of product added or removed from the product line.

### BRIEF DESCRIPTION OF DRAWINGS

Reference will now be made to the following drawings:

FIG. 1 is a block diagram illustrating an embodiment of a system for determining the number of products;

FIG. 2 is an apparatus illustrating an embodiment of a product pusher system for determining the number of products;

FIG. 3 is an embodiment illustrating a flow diagram of a method for determining a product measurement and/or description; and

FIG. 4 is an embodiment illustrating a flow diagram of a method for determining number of products; and

FIG. 5 is an embodiment illustrating the use of a product pusher.

### DETAILED DESCRIPTION

In the descriptions that follow, like parts are marked throughout the specification and drawings with the same numerals, respectively. The drawing figures are not necessarily drawn to scale and certain figures may be shown in exaggerated or generalized form in the interest of clarity and conciseness.

It will be appreciated by those skilled in the art that aspects of the present disclosure may be illustrated and described herein in any of a number of patentable classes or context including any new and useful process, machine, manufacture, or composition of matter, or any new and useful improvement thereof. Therefore, aspects of the present disclosure may be implemented entirely in hardware or combining software and hardware implementation that may all generally be referred to herein as a “circuit,” “module,” “component,” or “system” (including firmware, resident software, micro-code, etc.). Further, aspects of the present disclosure may take the form of a computer program product embodied in one or more computer readable media having computer readable program code embodied thereon.

Aspects of the present disclosure are described herein with reference to flowchart illustrations and/or block diagrams of methods, systems and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

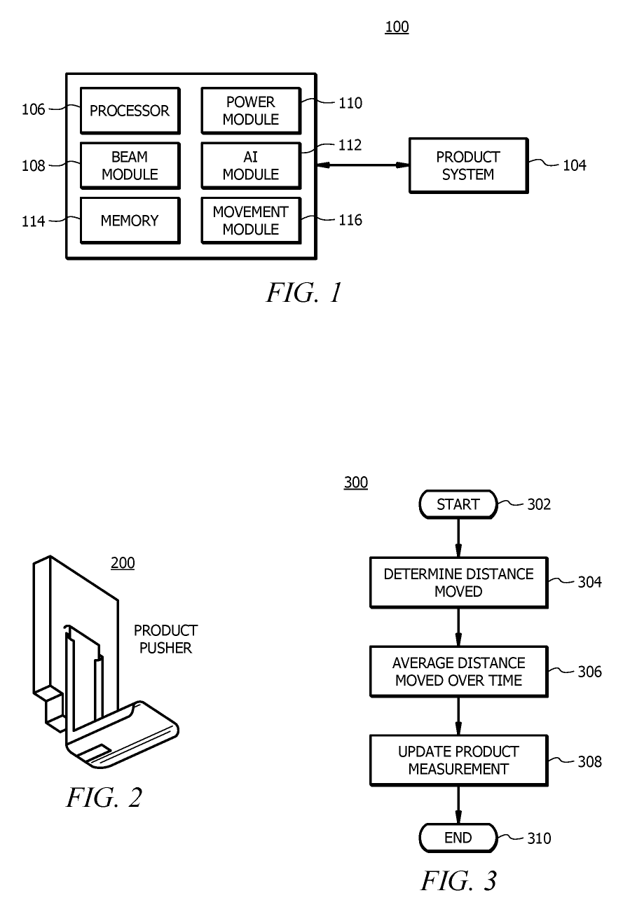

FIG. 1 is a block diagram illustrating an embodiment of a product counting system 100 for determining the number of products. The system 100 includes intelligent module 102 and product system 104. The intelligent module 102 moves location when a product is removed or added within its monitoring space, as shown and further described in FIG. 5. The intelligent module 102 includes a processor 106, beam module 108, power module 110, artificial intelligence 112, memory 114, movement module 116 and product recognition module 118.

Computer program code for carrying out operations utilizing the processor 106 for aspects of the present disclosure may be written in any combination of one or more programming languages, markup languages, style sheets and JavaScript libraries, including but not limited to Windows Presentation Foundation (WPF), HTML/CSS, XAML, and JQuery, C, Basic, *Ada, Python, C++, C#, Pascal, *Arduino. Additionally, operations can be carried out using any variety of compiler available.

The power module 110 is utilized to power/maintain power to the intelligent module 102. The power module 110 may be a low power and might be charged wired or wireless. In one embodiment, the power module 110 may utilize one or combination of the following battery, WIFI charging, coil, solar cells, or any other mechanism that provides charge to the intelligent module 102. For example, the power module 110 includes a low power source, such a battery, charge by coil, wired or wireless charge mechanism, electric charge, solar, or any source of power.

These computer program instructions may also be stored in memory 114 that when executed can direct processor 106, other programmable data processing apparatus, or other devices to function in a particular manner, such that the instructions when stored in memory 114 or any computer readable medium produce an article of manufacture including instructions, when executed, cause a computer to implement the function/act specified in the flowchart and/or block diagram block or blocks. The computer program instructions may also be loaded onto a computer, processor, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The memory 114 is used to archive any data, executable instructions or the like. The memory 114 is any combination of one or more computer readable media. The computer readable media may be a computer readable signal medium, any type of memory or a computer readable storage medium. For example, a computer readable storage medium may be, but not limited to, an electronic, magnetic, optical, electromagnetic, or semiconductor system, apparatus, or device, or any suitable combination of the foregoing. More specific examples of the computer readable storage medium would include, but are not limited to: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. Thus, memory 114 or the computer readable storage medium may be any tangible medium that can contain or store a program for use by or in connection with an instruction execution system, apparatus, device and the likes.

In one embodiment, the movement module 116 determines when there is a movement. The movement module 116 may utilize an accelerometer, infrared device, a light sensor, an image capturing device, a movement sensor, and the likes. The movement module 116 may also trigger the processor 106, the artificial intelligence 112 and the beam module 108 to calculate the movement of the product line, as further described and shown in FIG. 5. The initial product line distance or location is calculated at calibration time or archived in memory.

In one embodiment, the artificial intelligence 112 may comprise an image capturing device, a fixed focus camera, a video recorder, an infrared device and the likes. The artificial intelligence 112 learns the measurement and/or type of the product by monitoring the product line movement. The artificial intelligence 112 may also utilize an image capturing device or a bar code reader to determine a product type. In such an embodiment, an image capturing device may take images of the product closest to the intelligent module 102. The image is then utilized to identify a product. As the intelligent module 102 changes locations, the size of the product is learned and associated to the product image captured by the artificial intelligence module 112. As such, the product type may be identified and its measurements may be learned without utilizing external resources, such as, databases, product logs, or special codes. In another embodiment, the product type or measurement may be retrieved by the intelligent module 102 from external devices or resources, such as, product system 104, human entry, product identifiers and the like.

A product system 104 may be an inventory system or any database. In one embodiment, the product system 104 archives the determination of the product number from the intelligent module 102. The beam module 108 may be used to determine if items are in the product line. In one embodiment, the beam module 108 is used to determine the initialization of the product time or first product input. The beam module 108 may utilize a lidar beam or any laser beam used for determining a distance or to determine if any product is in the product line. Multiple beam modules 108 may be utilized in the intelligent module 102.

The intelligence module 102 may also include a light source, such as, flash, LED, serial flasher, dimmers, and the like. Such light source may be used to capture images in dark locations in the back of a shelf, in a refrigerator, in coolers, under products and the like. In one embodiment, a light diffuser may be used to avoid reflective lights. In another embodiment, a light source may also positioned away from reflective objects to avoid reflection.

The product system 104 is coupled to the intelligence module 102. The product system 104 may be coupled to the intelligence module 102 with wires, wirelessly, remotely or at the same location. The product system 104 and the intelligence module 102 ma communicate over a WIFI, LAN, ethernet, DSL, and the like. The product system 104 may include a database, data analysis module, a data archive module, inventory module, product identification data, or any combination thereof.

FIG. 2 is an apparatus illustrating an embodiment of a product apparatus 200 for determining the number of products. The product apparatus 200 utilizes the intelligent module 102. The product apparatus 200 functions as a product pusher and is triggered to move in a direction that changes the product line from the initial product line.

In one embodiment, the product apparatus 200 calculates the product line from its location behind a lineup of products on a shelf to the front of the shelf to be distance 1. In this embodiment, when a product is removed, the product apparatus 200 pushes the products to the front causing the distance to become distance 2=distance1−1product size. Similar calculations take place the next time a product is removed. As such the artificial intelligence module 112 of FIG. 1 learns or retrieves the measurement and/or description of the product. Thus, the distance from the product apparatus 200 top the product line can be calculated based on the learned product measurement and/or description. Thus, a movement means new product line, due to removal or addition of products, which results in a new product number. As such, in one embodiment, the data does not have to be captured or archived except when a change or movement in products/distance occurs and a new product line is calculated.

In one embodiment, an image capturing device, such as a camera (as described in FIG. 1) may be utilized to capture images. The image, images, or data identification based on the image is then used as a product identifier. The image capturing device may also be used to determine the product line and calculate/determine distance. For example, distance change may be used to determine distance and the number of products found on a shelf. In other embodiment, a beam, such as the beam module of FIG. 1, may be used to determine and calculate such distance.

FIG. 3 is an embodiment illustrating a flow diagram of a method 300 for determining a product measurement and/or description. The method 300 may be executed by an intelligence module 102 of FIG. 1. The method 300 starts at step 302 and proceeds to step 304, in which the method determines that there is a movement. At step 306, the method 300 averages the distances moved over time. At step 308, the method 300 determines the product measurement and/or description. The method 300 ends at step 310.

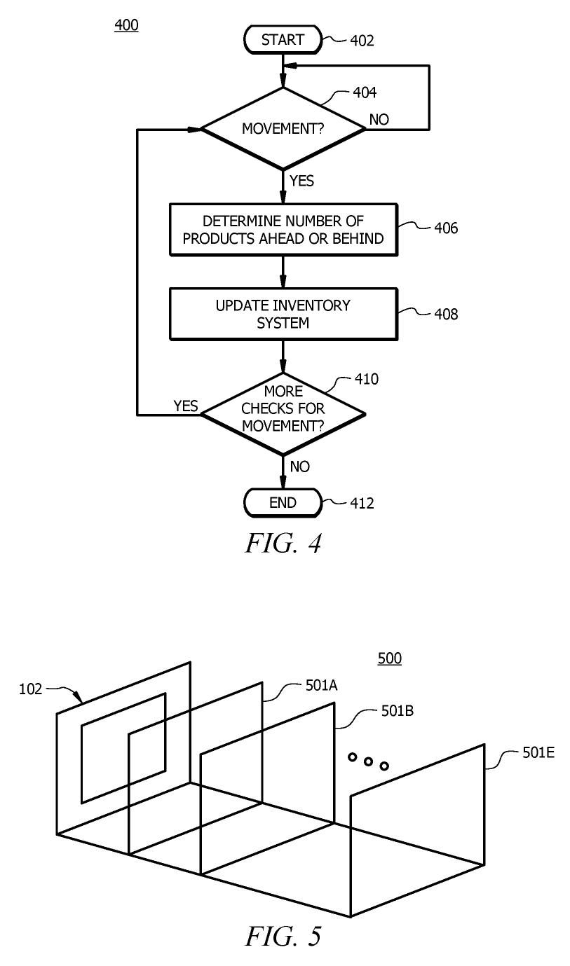

FIG. 4 is an embodiment illustrating a flow diagram of a method 400 for determining number of products. The method 400 may be executed by an intelligence module 102 of FIG. 1. The method 400 starts at step 402 and proceeds to step 404, in which the method determines if there is a movement. If there is no movement, the method 400 returns to step 404; otherwise, the method 400 proceeds to step 406. At step 406, the method 400 determines the number of products ahead or behind by performing calculations that utilizes the distance to the product line compared to the measurement/description of the specific product. At step 408, the method 400 updates the product or inventory system. At step 410, the method 400 determines if there are more movements. If there is a movement, the method 400 proceeds to step 404 or 406. If there is no movement, the method 400 ends at step 412. The method 400 repeats as necessary.

FIG. 5 is an embodiment illustrating the use of a product pusher system, such as product pusher 200 of FIG. 2. In FIG. 5, products 501A, B . . . . E are set adjacent to the product pusher. In this embodiment, the products are depicted to sit in front of the product pusher. However, in other embodiments, the products may be behind, next to, or combination thereof. When a product is removed or added, the pusher moves in the direction, calculates the change in distance and determines the number of products that have been removed. In FIG. 5, only one product pusher system is shown. In other embodiments, multiple product pusher systems may be used in parallel or facing different directions. Also, in this embodiment, the only one product line is being monitored. In other embodiments, a product pusher system may be

It will be appreciated by those skilled in the art that changes could be made to the embodiments described above without departing from the broad inventive concept. It is understood, therefore, that this disclosure is not limited to the particular embodiments herein, but it is intended to cover modifications within the spirit and scope of the present disclosure as defined by the appended claims.

1. A product counting system, comprising:
an intelligent module, wherein the intelligent module comprises a processor, beam module 108, an artificial intelligence, and movement module;
the movement module determines a movement in product line, wherein the product line increases or decreases by adding or removing product, and wherein the distance of the product line from the product counting system is determined by the processor utilizing the beam module; and
wherein the change in distance from the product line is utilized by the artificial intelligence to learn at least one of the measurement of the product, the description of the product and the number of product added or removed from the product line.

2. The product counting system of claim 1 further comprising a power module, wherein the power module provides power to the product counting system utilizing wired or wireless charge.

3. The product counting system of claim 2, wherein the power module utilizes a battery, WIFI charging, coil, solar cells, electric plug connection, wireless charge or combination thereof.

4. The product counting system of claim 3 further comprising a product recognition module, wherein the product recognition module communicates with a product system.

5. The product counting system of claim 4 further comprising an image capturing device.

6. The product counting system of claim 5, wherein the image capturing device is utilized to determine the product line and determine distance from the product counting system.

7. The product counting system of claim 5, wherein the image capturing device captures images to identify products in the product line.

8. The product counting system of claim 7, wherein the movement module utilizes an accelerometer, infrared device, a light sensor, an image capturing device, or a movement sensor.

9. The product counting system of claim 8, wherein the movement module triggers the product counting system to calculate the movement of the product line and to determine initial product line distance or location, and wherein the movement module calculated movement is utilized to determine the size of the product in the product line by averaging the movement of the product counting system over time and without utilizing external resources.

10. The product counting system of claim 9, wherein artificial intelligence comprises an image capturing device, a fixed focus camera, a video recorder, bar code reader or an infrared device to learn the measurement or type of the product.

11. A product counting method utilizing a product counting system, comprising:
initializing the product counting system by determining initial product line distance utilizing a lidar beam or an image capturing device;
determining a movement has occurred utilizing an accelerometer and, when movement occurs, determine the distance moved utilizing a lidar beam to determine the distance of the product line from the product counting system; and
determine the number of products added or removed by utilizing the product size and the distance moved;

12. The product counting method of claim 11, wherein the image capturing device captures an image and the image is utilized to determine if there is no products in the product line.
